(19) United States
(12) Patent Application Publication
(10) Pub. No.: US 2018/0054458 A1
(43) Pub. Date: Feb. 22, 2018

(54) SYSTEM AND METHOD FOR MITIGATING DISTRIBUTED DENIAL OF SERVICE ATTACKS IN A CLOUD ENVIRONMENT

(71) Applicant: DDOS NET, INC., San Francisco, CA (US)

(72) Inventors: Shawn J. Marck, Orangevale, CA (US); Robert C. Smith, Plano, TX (US)

(21) Appl. No.: 15/241,920

(22) Filed: Aug. 19, 2016

(51) Int. Cl. H04L 29/06

(52) U.S. Cl. CPC H04L 63/1458; H04L 67/10; H04L 63/101

(57) ABSTRACT

A data network includes a data processor, a network device, and a DDoS Protection System (DPS). The data processor provides an application to a user system. The network device routes application data traffic between the data processor and the user system. The DPS receives first telemetry information related to the application from the data processor and second telemetry related to the data traffic from the network device, delimits the telemetry information into telemetry information chunks comprising that portion of the telemetry information having a time-stamp that is within a corresponding time-stamp window, processes each telemetry information chunk in to a Reactor Telemetry Record (RTR) that includes a portion of the corresponding telemetry information chunk, analyzes the RTRs to determine if the data network is experiencing a DDoS attack, and initiates a response when the data network is experiencing a DDoS attack.

### FIELD OF THE DISCLOSURE

The present disclosure generally relates to mitigating distributed denial of service attacks, and more particularly relates to mitigating distributed denial of service attacks in a cloud environment.

### BACKGROUND

A network, such as the Internet, allows users of the network to access the resources of a datacenter. A distributed denial-of-service attack (DDoS) attack is an attempt to make the resources of the network unavailable to the users through a concerted effort by multiple infected computers (bots) to prevent a targeted site or service of the datacenter from operating efficiently. Perpetrators of DDoS attacks typically target sites or services hosted on high-profile web servers such as banks, credit card payment gateways, and even root name servers. A common attack involves saturating the target machine with external communications requests, so that it cannot respond to legitimate traffic, or so that it responds so slowly that the target is effectively unavailable to legitimate traffic. As such, DDoS attacks can lead to a server overload, thus forcing the targeted computer to reset. The scope and content of DDoS attacks is constantly being adapted and changed in order to adapt to changes in the network environment, and to surmount improved network security measures that are employed by the network operator.

FIG. 1 illustrates a network 100, as is known in the art, such as the Internet or a private internet. Network 100 includes user systems 101, 102, 103, 104, 105, and 106 (user systems 101-106), an autonomous system (AS) 110, a route controller 120, and a network datacenter 130. AS 110 includes edge routers 112, 114, and 116, and a core router 118. Network datacenter 130 includes a load balancer 132, an application server 134, a database server 136, a datacenter security system 138, and a DDoS mitigation appliance 140. AS 110 routes data traffic between datacenter 130 and user systems 101-106. The data traffic can include requests to access to the resources and operations of the datacenter 130. Communication between network datacenter 130 and AS 110 is provided by core router 118. Here, user systems 101 and 102 access network datacenter 130 through edge router 112 and core router 118, user systems 103 and 104 access the network datacenter through edge router 114 and the core router, and user systems 105 and 106 access the network datacenter through edge router 116 and the core router. Route controller 120 exchanges route information between edge routers 112, 114, and 116, and core router 118, receives routing layer logs 121 from the edge routers and the core router, and receives load information 122 for the links between the edge routers and the core router.

Network datacenter 130 is a centralized repository for the storage, management, and dissemination of data and information related to a particular enterprise. Application server 134 represents one or more processing resources that are configured to provide a data or information processing operation, such as a hosted application, to user systems 101-106. Similarly, database server 136 represents one or more processing resources that are configured to provide a different data or information processing operation, such as a hosted database, to user systems 101-106. Data traffic from user systems 101-106 to network datacenter 130 is routed from core router 118 to load balancer 132, that distributes the data traffic from user systems 101-106 across one or more instantiations of application server 134 and one or more instantiations of database server 136 in order to ensure that the data traffic is distributed to evenly utilize the capabilities and capacities of the application server and the database server. Datacenter security system 138 ensures that the resources of datacenter 130 are safely and securely administered, and that the resources are available when requested. Thus, datacenter security system 138 represents hardware and software tools and appliances that keep the resources of datacenter 130 free from internal and external threats that prevent unauthorized access to the resources of the datacenter, and that protect the resources of the datacenter from attack. Datacenter security system 138 can include a firewall, a proxy, a web-based demilitarized zone (DMZ), an intrusion detection system (IDS), an intrusion prevention system (IPS), anti-virus and anti-malware protection software, spam blocking software, other hardware or software tools or appliances that ensure the safety, security and availability of the resources of datacenter 130, or a combination thereof.

One or more of user systems 101-106 can be infected to become a part of a botnet. A botnet command and control (C&C) system 108 utilizes some or all of the computing resources of the infected user systems, also referred to as bots or zombies, to attack a victim. The infected user systems may be recruited into the botnet by downloading and running malicious software that turns over the computing resources of the infected user system to botnet C&C system 108. The malicious software can be installed on user systems 101-106 by a drive-by download that exploits vulnerabilities on the user system, by tricking a user into running a Trojan program by opening an infected e-mail attachment, by browsing to websites that install spyware, adware, botware, or other malicious software, or by otherwise installing and running malicious software. Botnet C&C system 108 aggregates the resources of the infected user systems to perform an attack on a victim, such as a node of AS 110, or a computing resource of datacenter 130. An attack can include a DDoS attack, spreading of adware, spyware, botware, or other malicious software, e-mail spam, click fraud, or other types of attacks. In particular, botnet C&C system 108 may perform different types of attacks using various combinations of infected user systems.

Network 100 is illustrated as experiencing several DDoS attacks. Here, botnet C&C system 108 directs user systems 101-106 to launch a volume DDoS attack 152 on AS 110, and to launch an application DDoS attack 154 on datacenter 130. Both of DDoS attacks 152 and 154 consume the computational resources of one or more elements of AS 110 or datacenter 130, to disrupt configuration information such as routing information, to disrupt network state information such as by resetting TCP sessions, to disrupt the normal communications between user systems 101-106 and the elements of the AS, or to implement another type of disruption to the elements of the AS or the datacenter. For example, DDoS attacks 152 and 154 can overload a victim's processing devices, over-utilize the victim's memory resources, exceed a stack limit or the victim's data bandwidth capacity, trigger microcode or instruction sequencing errors, exploit vulnerabilities in the victim's hardware, software, or firmware, including known processor errata, unpatched operating systems or unpatched software suites executed on the operating system, or otherwise disrupt the victim's hardware or software.

Volume DDoS attack 152 consumes the computational resources, disrupts the configuration information, or disrupts the network state information within network 100 by performing a layer 3/layer 4 (L3/L4) attack on the elements of AS 110 using protocols and services in the Open Systems Interconnection (OSI) model network layer (L3) or in the transport layer (L4). For example, volume DDoS attack 152 can include an Internet Control Message Protocol (ICMP) flood, a Transmission Control Protocol/Internet Protocol (TCP/IP) synchronize (SYN) flood or synchronize/acknowledge (SYN-ACK) flood, a TCP/IP fragmentation attack, another L3 or L4 attack, or a combination thereof. Route controller 120 is positioned in AS 110 to mitigate volume DDoS attack 152 by detecting increases in the types of network traffic associated with L3 and L4 attacks, because data traffic routing in the AS is based upon L3 and L4 protocols. In particular, route controller 120 receives routing layer logs 121 from edge routers 112, 114, and 116, and from core router 118, and, based upon an evaluation of the information included in the routing layer logs, acts to mitigate volume DDoS attack 152 by minimizing or eliminating the effects of the attack

Application DDoS attack 154 consumes the computational resources, disrupts configuration information, or disrupts application state information of datacenter 130 by targeting the OSI model application layer (L7) elements of the datacenter. For example, application DDoS attack 154 can include an attack on HyperText Transport Protocol (HTTP) or secure HTTP (HTTPS) applications, Domain Name System (DNS) services, other L7 protocols, or other applications or operations that are accessible through L7 interactions. Application DDoS mitigation appliance 140 is positioned in datacenter 130 to mitigate application DDoS attack 154 by detecting increases in the types of network traffic associated with L7 attacks based on, for example, a deep packet inspection performed by load balancer 132 that determines the type of L7 application to which the transactions are targeted. In particular, application DDoS mitigation appliance 140 receives application layer logs 141 from load balancer 132, application server 134, database server 136, and datacenter security system 138, and, based on an evaluation of the information in the application layer logs, determines a set of confirmed malicious IP addresses 142 that are exported to edge routers 112, 114, and 116. Edge routers 112, 114, and 116 then filter or redirect the data traffic associated with application DDoS attack 154.

Note that, as the traffic handled by network 100 increases, the number of elements of AS 110 and datacenter 130 also increases in order to maintain a desired service level for the products and services provided by the network. In particular, the addition of more user systems seeking the products and services of the network necessitates the addition of more edge routers, core routers, and route controllers in AS 110, so that the AS can successfully route the added traffic without experiencing dropped packets, bottlenecks, or other routing degradations. Similarly, the added requests from the additional user systems necessitates the addition of more load balancers, application servers, database servers, and datacenter security systems in datacenter 130 so that the requests can be handled in a timely manner and without undue degradation of service. As such, as the traffic handled by network 100 increases, the number of elements of the network that are providing routing layer logs 121 to route controller 120, and that are providing application layer logs 141 to application DDoS mitigation appliance 140 will likewise increase. The increase in log information necessitates greater processing resources for route controller 120 and application DDoS mitigation appliance 140, in order to maintain a consistent level of protection against volume and application DDoS attacks. For example, an increase in log information may necessitate added bandwidth between the elements of AS 110 and route controller 120, and greater data storage and processing capacity in the route controller.

Moreover, the log information from several of the elements of AS 110 and of datacenter 130 may need to be correlated together to adequately detect a DDoS attack. However, at the same time, the addition of elements to AS 110 and to datacenter 130 may permit wider avenues of attack, making the correlation of the log information more difficult. Thus the tasks of scaling DDoS mitigation resources and correlating log information to detect a DDoS attack in network 100 is an ongoing challenge, and there remains a need for a DDoS mitigation solution that more easily scales with the associated network, and that more effectively correlates the received log information to detect DDoS attacks.

FIG. 2 illustrates a cloud network 200, as is known in the art, including user systems 201, 202, 203, 204, 205, and 206 (user systems 201-206), and a cloud computing system 210. Cloud computing system 210 represents a shared processing resource to provide on-demand computing functionality for a client 220, typically an enterprise or business that provides services to user systems 201-206. Client 220 operates a virtual application server 212 and a virtual database server 214 on cloud computing system 210 to provide some or all of the operations associated with a datacenter similar to datacenter 130, with an AS similar to AS 110, or both. Cloud computing system 210 relies on virtualization technology to flexibly allocate the resources of the cloud computing system to meet the demands from user systems 201-206 on an as-needed basis. Here, virtual application server 212 is similar to application server 134, providing a data or information processing operation, such as a hosted application, to user systems 201-206, and virtual database server 214 is similar to database server 136, providing a different data or information processing operation, such as a hosted database, to user systems 201-206

Cloud computing system 210 represents a data processing capacity that is operated by a cloud service provider who offers cloud-based data and information processing operations to clients 220. The cloud services may be offered free or for a fee. Here, it is understood that multiple enterprises may receive the cloud services offered by cloud computing system 210. An example of cloud computing system 210 includes Amazon Web Services (AWS), Microsoft® cloud services such as Azure, IBM® cloud services such as Softlayer®, Google™ Cloud Platform services, Salesforce® cloud services, or another cloud service provider.

Cloud computing system 210 can be deployed utilizing one of several different models, including an Infrastructure-as-a-Service (IaaS) model and a Platform-as-a-Service (PaaS) model. In the IaaS model, cloud computing system 210 is offered to client 220 as physical infrastructure in a datacenter, or as bare virtual machine resources or containerized processing environments. Here, client 220 installs, sets up, and maintains operating systems, software, programs, and applications on the physical servers, bare virtual machines, or containerized environments to provide the operations and features associated with virtual application server 212 and with virtual database server 214. Client 220 can also set-up and maintain network routing resources of cloud computing system 210. In the IaaS model, the cloud service provider is typically only responsible to maintain the physical infrastructure of cloud computing system 210, while client 220 is responsible to maintain their operating systems, software, programs, and applications.

In the PaaS model, cloud computing system 210 is offered to client 220 as a standard platform, including physical infrastructure in a datacenter, virtual machine resources, or containerized processing environments. However, here, the physical infrastructure, virtual machine resources, or containerized processing environments are typically pre-populated with an operating system, and standard software, programs, and applications, upon which client 220 can develop and run virtual application server 212 and virtual database server 214. In the PaaS model, the cloud service provider is typically responsible to maintain the physical infrastructure, and the standard platforms, while client 220 is responsible to maintain the setup, configuration, and client specific programming of the standard platforms.

One or more of user systems 201-206 can be infected to become a part of a botnet under the control of a botnet C&C system 208 to implement a DDoS attack on cloud computing system 210. Where cloud computing system 210 is offered as an IaaS-based system, client 220 can implement and control the mitigation of DDoS attacks by instantiating a virtual datacenter security system similar to datacenter security system 138, and a virtual DDoS mitigation appliance similar to DDoS mitigation appliance 140. Here, the virtual datacenter security system, virtual application server 212, and virtual database server 214 can provide log information to the virtual DDoS mitigation appliance. Further, where client 220 sets-up and maintains network routing resources of cloud computing system 210, the client can instantiate a virtual route controller similar to route controller 120 to further implement and control the mitigation of DDoS attacks. However, such a solution suffers similar problems as are inherent with network 100, namely, the tasks of scaling DDoS mitigation resources and correlating log information to detect a DDoS attack in an IaaS-based cloud computing system is an ongoing challenge, and there remains a need for a DDoS mitigation solution that more easily scales with the associated network, and that more effectively correlates log information with DDoS attacks.

Moreover, where cloud computing system 210 is offered as a PaaS-based system, client 220 loses access to log information, and is increasingly at the mercy of the cloud service provider to effectively neutralize DDoS attacks, and the client thus is less able to implement, monitor, or control the mitigation of DDoS attacks that may be narrowly targeted to the client's services. Thus there remains a need to receive, monitor, and process log information from a cloud processing system to effectively provide DDoS mitigation that is targeted to a particular client's needs.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a network according to the prior art;

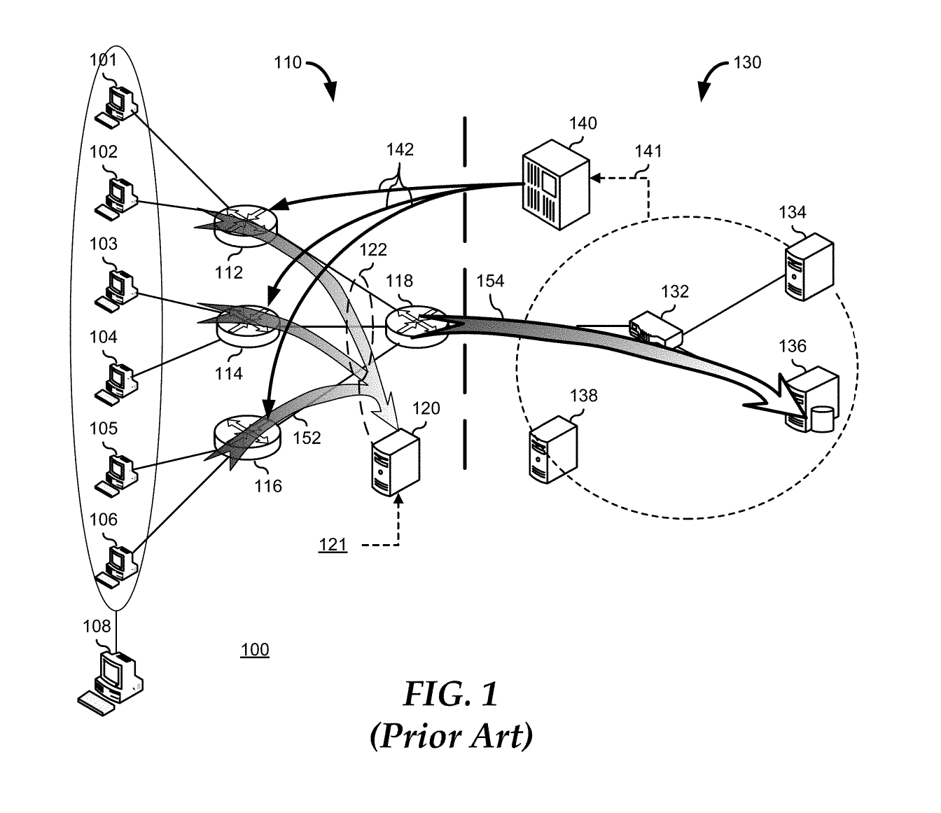

FIG. 2 is a block diagram of a cloud network according to the prior art;

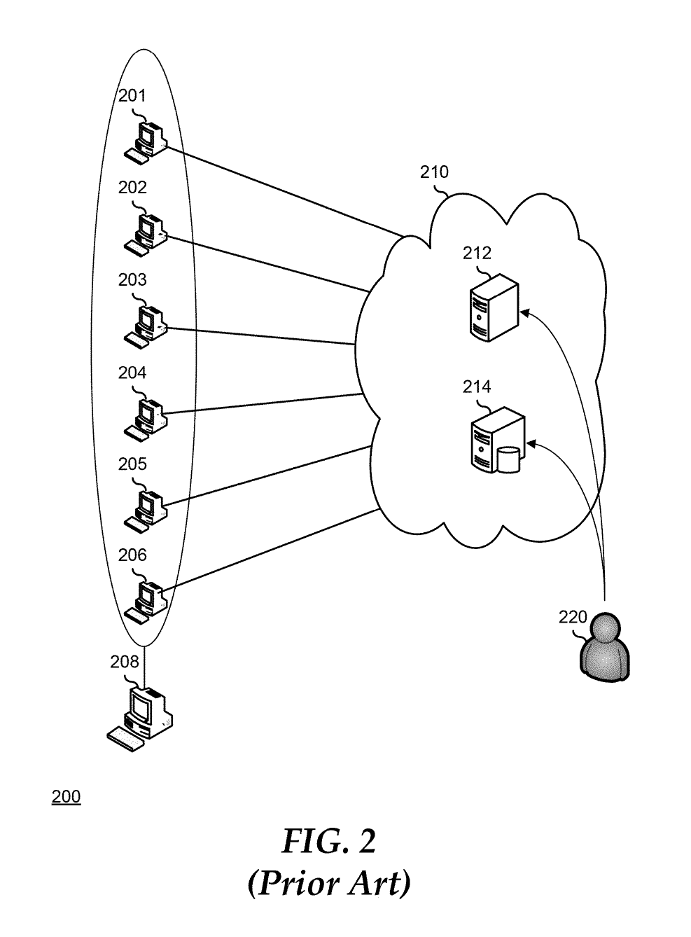

FIG. 3 is a block diagram of a cloud network according to an embodiment of the present disclosure;

FIG. 4 is a block diagram of the DDoS protection system of the cloud network of FIG. 3;

FIG. 5 is a flowchart illustrating a method of providing DDoS attack protection in a cloud network according to an embodiment of the present disclosure;

FIG. 6 is an illustration of a Reactor Telemetry Record according to an embodiment of the present disclosure;

FIG. 7 is a flowchart illustrating a method of generating a Reactor Telemetry Record according to an embodiment of the present disclosure; and

FIG. 8 is a block diagram of a general computer system according to an embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

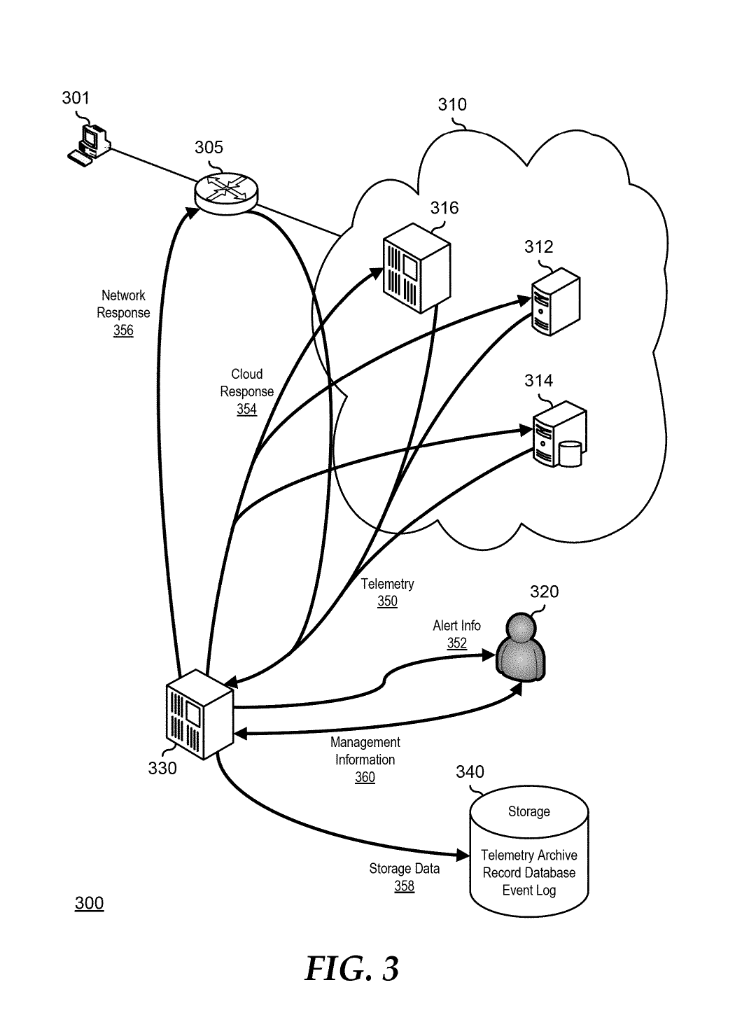

FIG. 3 illustrates an embodiment of a cloud network 300, including a user 301, a routing network 305, a cloud computing system 310, a client 320, a DDoS Protection System (DPS) 330, and a storage element 340. Cloud computing system 310 includes a virtual application server 312, a virtual database server 314, and a cloud management system 316, and represents a shared processing resource established to provide computing services to user 301 at the behest of client 320. Virtual application server 312 represents processing resources that are configured to provide a particular service, such as a hosted application, and virtual database server 314 represents different processing resources that are configured to provide a different service, such as a database service. For example, virtual application server 312 and virtual database server 314 can operate to provide a web or electronic mail (e-mail) hosting service associated with an ISP, a cache server capacity of a CDN, a media storage and distribution service of an IPTV network, an application and data capacity of a proprietary network, a data, web, application, and Voice-over-Internet Protocol (VoIP) service of a wireless data network or cellular telephone system, or another data and information storage, management, and dissemination service. Cloud computing system 310 can include additional processing resources, such as additional application or database servers, data storage resources, or other resources, as needed or desired. Cloud management system 316 operates as an interface point for client 320 to set-up, configure, and maintain virtual application server 312 and virtual database server 314.

Cloud computing system 310 can include a security overlay (not illustrated) that ensures that the cloud computing system 310 is safely and securely administered, and that the resources of the cloud computing system are available when requested. The security overlay can operate to keep the resources of cloud computing system 310 free from internal and external threats, to prevent unauthorized access to the resources of the cloud computing system, and to protect the resources of the cloud computing system from attack. For example, a security overlay can include a firewall, a proxy, a web-based demilitarized zone (DMZ), an intrusion detection system (IDS), an intrusion prevention system (IPS), anti-virus and anti-malware protection software, spam blocking software, or other hardware or software tools or appliances that ensure the safety, security and availability of the resources of cloud computing system 310.

Routing network 305 represents a data network, such as an AS, that includes a core router and one or more edge routers, and that routes data traffic between user 301 and cloud computing system 310. An example of routing network 305 includes a routing network associated with an Internet service provider (ISP), a content delivery network (CDN), an Internet Protocol Television (IPTV) network, a wireless data network or cellular telephone system, or another routing network. The elements of routing network 305 can communicate with each other and advertise their respective network connections through various internal or external routing protocols, such as an Open Shortest Path First (OSPF) protocol, a Routing Information Protocol (RIP), an Intermediate-System-to-Intermediate-System (IS-IS) protocol, a Border Gateway Protocol (BGP), an Exterior Gateway Protocol (EGP), or another routing protocol.

User 301 represents one or more user systems that can be under the control of a botnet C&C system (not illustrated) to launch DDoS attacks against cloud network 300. The DDoS attacks operate to overload a victim's processing devices, to over-utilize the victim's memory resources, to exceed a stack limit or a data bandwidth capacity, to trigger microcode errors or instruction sequencing errors, to exploit vulnerabilities in the victim's hardware, software, or firmware, including known processor errata, unpatched operating systems or unpatched software suites executed on the operating system, or to otherwise disrupt the victim's hardware or software. Here, the botnet C&C system can direct user systems 301 to launch volume DDoS attacks on routing network 305 and the network functions of cloud computing system 310, or to launch application DDoS attacks against virtual application server 312 and virtual database server 314 to consume the computational resources of the elements of cloud network 300, to disrupt configuration information such as routing information, to disrupt network state information such as by resetting TCP sessions, to disrupt the normal communications between users 301 and the elements of the cloud network, or to implement another type of disruption to the elements of the cloud network.

DPS 330 operates to detect and respond to volume and application DDoS attacks by user 301 against cloud computing system 310. In particular, DPS 330 monitors network resources of cloud network 300, provides real-time visibility into the network and application level performance statistics, collects, aggregates, and processes telemetry information from the cloud network, analyzes the processed telemetry information to determine the presence of DDoS attacks, defines network and application performance thresholds and alert policies based upon the analysis, propagates flow and route restrictions to mitigate DDoS attacks, provides historical trend analysis and reporting to client 320, and provides a dashboard for the client's network operations center (NOC) and security operations center (SOC).

In monitoring the network resources of cloud network 300, DPS 330 receives telemetry information 350 from routing network 305, virtual application server 312, virtual database server 314, and cloud management system 316. Telemetry information 350 represents information related to the status and operation of the particular source of the telemetry information. Telemetry information 350 includes network flow log information, application flow log information, application statistics information, cloud and server utilization information, or other information related to the operation of cloud network 300. For example, where telemetry information 350 represents flow log information, the telemetry information can include netflow information, sflow information, virtual private network (VPN) flow information, application flow information, or other information such as may be derived from the network traffic through cloud network 300, or that may otherwise be derived from data packets flowing through the cloud network, including deep packet inspection of the data packets or other packet flow analysis tools. In another example, where telemetry information 350 represents application flow log or application statistics information, the telemetry information can include application flow information such as may be derived from applications running on cloud computing system 310, including application logs and statistics received from virtual application server 312, virtual database server 314, and cloud management system 316, and that may relate to the utilization of the operations and features provided by the virtual application server, the virtual database server, and the cloud management system. In a further example, where telemetry information 350 represents cloud and server utilization information, the telemetry information can include physical or virtual component utilization levels, such as CPU utilization levels, memory utilization levels, I/O bandwidth utilization levels, storage utilization levels, network routing utilization levels, and the like.

In providing real-time visibility into the network and application level performance statistics, DPS 330 provides telemetry information 350 directly to storage element 340, as unprocessed storage data 358. That is, the raw telemetry information 350 is stored for later correlation or in case a particular DDoS attack profile necessitates a deeper analysis of the telemetry information. In a particular embodiment, telemetry information 350 is stored in storage element 340 for a limited duration of time, such as for one day or for one week, after which new telemetry information can be stored in place of older telemetry information. In this way, the storage capacity of storage element 340 that is dedicated to storing telemetry information 350 does not continuously increase. In another embodiment, older telemetry information can be saved to a long-term storage archive, as needed or desired.

Further, in providing real-time visibility into the network and application level performance statistics, and in aggregating and processing telemetry information 350, DPS 330 breaks the telemetry information into chunks of telemetry information based upon a time stamp window within which each entry of the telemetry information is generated. As such, each entry of telemetry information 350 that is tagged with a time stamp that is within a particular time stamp window is included in the chunk of telemetry information associated with that particular time stamp window, and entries of telemetry information 350 that are tagged with time stamps that are either before or after the particular time stamp window are not included in the chunk of telemetry information associated with that particular time stamp window. Thus, a time stamp window demarks a unique and contiguous duration of time. For example, where a time stamp window has a one (1) minute duration, a first time stamp window can demark a first chunk of telemetry information 350 that includes entries of the telemetry information that are generated with time stamps having values between 23:59:00 and 23:59:59, and a next time stamp window can demark a second chunk of the telemetry information that includes entries of the telemetry information that are generated with time stamps having values between 00:00:00 and 00:00:59. A time stamp window duration can be longer than one (1) minute, such as five (5) minutes, ten (10) minutes, or another longer duration, or can be shorter than one (1) minute, such as ten (10) seconds, one (1) second, or another shorter duration. The time stamps associated with the entries of telemetry information 350 and with the time stamp windows can be defined in accordance with an ISO 8601 time representation, or another standard of time representation, as needed or desired. In a particular embodiment, the time stamp window duration is predefined. In another embodiment, client 320 can select a time stamp window duration, as needed or desired.

After DPS 330 breaks telemetry information 350 into chunks, the DPS, based upon a predetermined set of critical telemetry parameters, analyzes each chunk to determine critical values for each critical telemetry parameter in each entry of the chunk, and formats the critical values into a Reactor Telemetry Record (RTR), condensing each chunk into a smaller, more easily processed and analyzed block of information. The critical telemetry parameters represent parameters of telemetry information 350 that can provide key indicators of the presence of unwanted activity, such as DDoS attacks, on cloud network 300. For example, a typical critical telemetry parameter for the detection of a volume DDoS attack may include the source and destination IP addresses of transactions that are routed through routing network 305, as derived from the telemetry information received from the routing network. In another example, a typical critical telemetry parameter for the detection of an application DDoS attack my include an indication of a number of requests to receive a web page that are not also associated with requests for the content associated with the web page, as may be received from virtual application server 312. Here, each RTR includes a number of entries for each critical telemetry parameter, where each entry is associated with a number of top most common values for the particular critical telemetry parameter, thereby condensing telemetry information 350 into a single RTR for each time stamp window. RTRs will be more fully described below.

DPS 330 further operates to provide the RTRs to storage element 340 as an additional portion of storage data 358. In this way, telemetry information 350 is stored as RTRs for later correlation or in case a particular DDoS attack profile necessitates a deeper analysis of the RTRs. In a particular embodiment, the RTRs are stored in storage element 340 for a limited duration of time, such as for one month or for one year, after which new RTRs can be stored in place of older RTRs. In this way, the storage capacity of storage element 340 that is dedicated to storing RTRs does not continuously increase. In another embodiment, older RTRs can be saved to a long-term storage archive, as needed or desired.

In analyzing the processed telemetry data (i.e., the RTRs) to determine the presence of DDoS attacks, DPS 330 operates to analyze the RTRs to detect threats that are associated with known DDoS attack profiles, to identify anomalous behavior in the critical telemetry parameters stored in the RTRs that can signify a threat, or to otherwise detect a threat based upon the contents of the RTRs. In detecting patterns that are associated with known DDoS attack profiles, DPS 330 compares the RTRs with known DDoS attack profiles from a threat database and determines whether a particular RTR indicates the presence of a DDoS attack when the comparison indicates that the present conditions on cloud network 300 resemble a known DDoS attack. In a particular embodiment, the RTRs are utilized to instantly identify threats. For example, where a previously identified DDoS attack is perpetrated from a new IP address, the profile of the DDoS attack can have passed previously emplaced IP address blocking on routing network 305. Here, the profile of the new DDoS attack will match a profile of a known DDoS attack in the threat database, and the new IP address can be associated with a new threat based upon the known DDoS attack. In another embodiment, multiple RTRs are utilized to identify threats. For example, successive RTRs may indicate rising levels of activity in one or more parameters of the successive RTRs, and such rising activity can be determined to be associated with a known DDoS attack. In another example, a particular DDoS attack may not be easily identifiable by the behavior of cloud network 300 in a one-second time slice analysis, but may more fully manifest itself by behavior that occurs over an extended amount of time. Here, an RTR may be preliminarily marked as identifying a potential threat, and later RTRs can be analyzed to determine if the follow-up conditions on cloud network 300 matches a known DDoS attack. In another embodiment, a threat may be indicated by the fact that a particular parameter is above or below a network or application threshold. For example, a particular DDoS attack may not match a known DDoS attack in the threat database, but may be indicated by an unexpectedly high traffic volume on routing network 305. As such, a threat may be indicated when the traffic volume on routing network 305 exceeds a particular threshold.

When an event is detected, DPS 330 operates to provide event log information to storage element 340, as another portion of storage data 358. Additionally, DPS 330 operates to provide alert information 352 to client 320 to inform the client when an alert has been generated. For example, DPS 330 can provide alert information via a hosted web interface, via an e-mail exchange service, via a text or messaging exchange service, via another alert mechanism, or via a combination thereof, as needed or desired. Finally, when an event is detected, DPS 330 operates to determine reactions to the event. The reactions include a cloud response 354 and a network response 356. Cloud response 354 includes information directed to virtual application server 312, virtual database server 314, and cloud management system 316 to modify the behavior of the network operations of cloud computing system 310, and the application operations of the virtual application server and the virtual database server to minimize or eliminate the threat posed by the identified DDoS attack. For example, cloud response 354 can include flow and route restrictions for network elements of cloud computing system 310, flow and application restrictions for virtual application server 312 and virtual database server 314, other restrictions for the elements of the cloud computing system, or a combination thereof, as needed or desired. Network response 356 includes information directed to routing network 305 to modify the routing operations of the routing network to minimize or eliminate the threat posed by the identified DDoS attack. For example, network response 356 can include address and flow restrictions, Access Control List (ACL) entries, other types of IP and MAC address black list entries, that is, entries in a list of IP and MAC addresses from which traffic is blocked, other address or flow restrictions, or a combination thereof, as needed or desired.

In providing a dashboard for the client's NOC and SOC, DPS 330 operates to exchange management information 360 with client 320. Management information 360 includes information related to setting the parameters and information sent from routing network 305 and the elements of cloud computing system 310 in telemetry information 350. In addition, management information 360 includes information related to setting the parameters that are collected in the RTRs and the duration of the time stamp window associated with the RTRs. Further, management information 360 includes alert settings and threshold information for determining when to send alerts to client 320. Moreover, management information 360 includes response information for determining cloud response 354 and network response 356.

In a particular embodiment, DPS 330 operates to provide database functionality for the creation, manipulation, searching, querying, reporting, and viewing of RTRs in storage element 340. For example, DPS 330 can include a SQL database server, an XML database server, a SQL/XML database server, a NoSQL database server, or another database server to provide the database functionality as needed or desired. In particular, DPS 330 stores and retrieves RTRs in real-time in order to make single-RTR and multiple-RTR threat determinations, or the DPS can run queries and searches at a later time if a DDoS attack is experienced but not detected until it has had a significant effect. Here, a query of RTRs can uncover previously unrecognized indications of the DDoS attack that may be more apparent after the DDoS attack has matured. In this case, DPS 330 can identify the new DDoS attack after the fact, and can then update the threat database accordingly. Additionally, DPS 330 operates to modify the configuration of the RTRs in response to newly identified DDoS attacks, where the addition or modification of the set of recorded parameters can provide better early warning of a DDoS attack. In this regard, DPS 330 also operates to provide database functionality for the searching, querying, reporting, and viewing of the raw telemetry information 350 in storage element 340 in order to provide for deeper analysis and identification of new DDoS attack profiles. Here, the raw telemetry information 350 may include other previously unrecognized indications of the DDoS attack that may be able to be detected with the inclusion of other parameters in the RTRs.

In creating the RTRs, DPS 330 operates to attempt to capture all of telemetry information 350 that is received with a particular time stamp window. However, it is not guaranteed that all telemetry information 350 that is generated within the particular time stamp window will be received by DPS 330 at substantially the same time, and, more realistically, some portion of the telemetry information will not be received until long after the end of the time stamp window. Thus, DPS 330 includes mechanisms for determining when to close a particular RTR. In a particular embodiment, the RTR closure mechanism includes a list of critical parameters that must be received prior to the closure of the particular RTR, and the RTR will remain open until the telemetry information for each critical parameter has been received. In another embodiment, the RTR closure mechanism is provided based upon a time limit, and telemetry information 350 for the particular time stamp window will only be collected during the time limit, and at the end of the time limit, the RTR is closed. In yet another embodiment, a combination of critical parameter closure mechanism and the time limit closure mechanism is employed. Here, an RTR is closed at the end of the time limit, but in response to the receipt of telemetry information 350 that is on the critical parameter list, DPS 330 will reopen the particular RTR and append the critical telemetry information to the RTR.

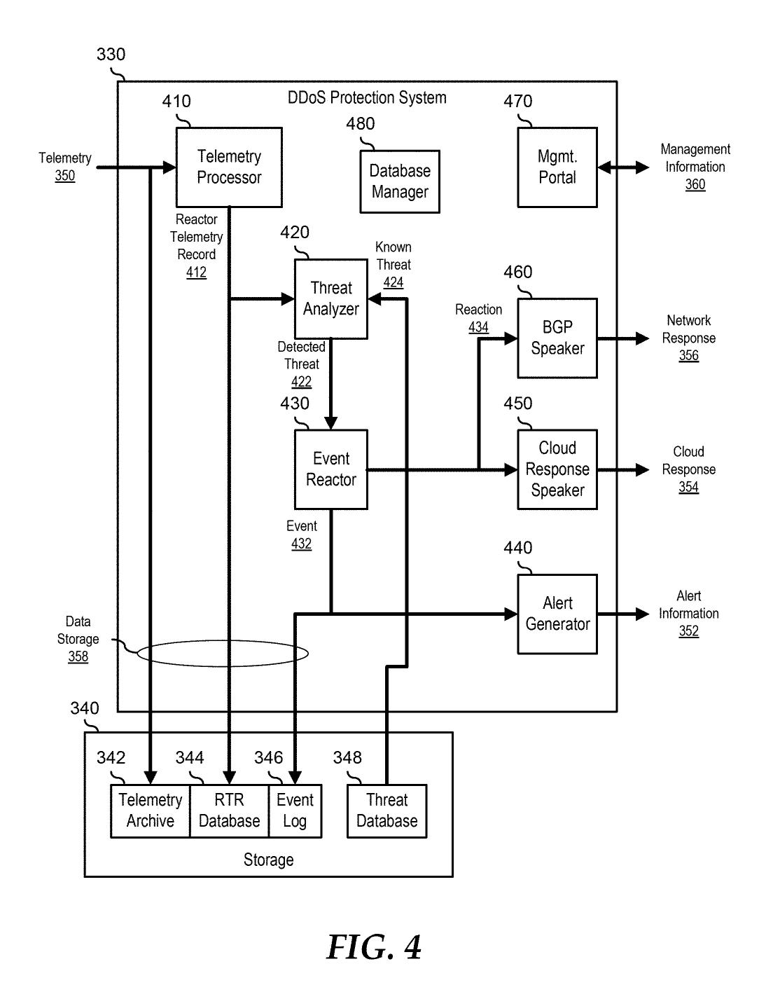

FIG. 4 illustrates an embodiment of DPS 330, including a telemetry processor 410, a threat analyzer 420, an event reactor 430, an alert generator 440, a cloud response speaker 450, a Border Gateway Protocol (BGP) speaker 460, a management portal 470, and a database manager 480. Here, storage element 340 includes a telemetry archive 342, an RTR database 344, an event log 346, and a threat database 348. Telemetry information 350 is provided directly to telemetry archive 342, and to telemetry processor 410. Telemetry processor 410 analyzes telemetry information 350 to determine sets of critical telemetry parameters, and to format the sets of telemetry parameters into RTRs 412, as described further below. Telemetry processor 410 stores RTRs 412 in RTR database 344, and provides the RTRs to threat analyzer 420.

Threat analyzer 420 receives and analyzes the RTRs to determine the presence of DDoS attacks. Here, threat analyzer 420 also receives known DDoS attack profiles, or known threats 424, from threat database 348, and compares the known threats with the RTRs to determine whether a particular RTR indicates the presence of a DDoS attack. If a DDoS attack is detected, threat analyzer 420 generates a detected threat indication 422 that is provided to event reactor 430. Event reactor 430 processes detected threat indication 422 and stores event information 432 to event log 346, and provides the event information to alert generator 440. Alert generator 440 determines the types of alerts that are to be provided to client 320 based upon event information 432, and provides alert information 352 to the client based upon the event information.

Event reactor 430 also determines reactions 434 to detected threat information 422 and provides the reactions to cloud response speaker 450 and to BGP speaker 460. Cloud response speaker 450 provides cloud response 354 to virtual application server 312, to virtual database server 314, and to cloud management system 316 to modify the behavior of the network operations of cloud computing system 310, and the application operations of the virtual application server and the virtual database server to minimize or eliminate the threat posed by the identified DDoS attack. BGP speaker 460 provides network response 356 to routing network 305 to modify the routing operations of the routing network to minimize or eliminate the threat posed by the identified DDoS attack.

Management portal 470 provides the dashboard for the client's NOC and SOC and exchanges management information 360 with client 320. Database manager 480 provides the database functionality for the creation, manipulation, searching, querying, reporting, and viewing of RTRs in RTR database 344, and provides for searching, querying, reporting, and viewing of the raw telemetry information 350 in telemetry archive 342.

In a particular embodiment, the cloud service provider restricts the transmission and communication of telemetry information 350, such that the telemetry information from virtual application server 312, virtual database server 314, and cloud management system 316 may not be transmitted or communicated outside of cloud computing system 310. Here, in order to take advantage of telemetry information 350 from virtual application server 312, virtual database server 314, and cloud management system 316, DPS 330 is instantiated within cloud computing system 310. Here, DPS 330 can be instantiated as a separate virtual machine or partitioned cloud environment, or can be instantiated to operation within one of virtual application server 312 or virtual database server 314, as needed or desired.

Note that formatting the critical telemetry parameters into time stamp window based RTRs, condenses telemetry information from a cloud network into smaller, more easily processed and analyzed blocks of information, than would be the case where the raw telemetry information is processed and analyzed. Moreover, the provision of RTRs based upon the time stamp window provides a critical time-based view of the conditions on the cloud network, where such a view based upon the raw telemetry information would require additional processing to enforce a time-based analysis on the raw telemetry information. Further, by analyzing the condensed telemetry information in the RTRs, only the critical parameters are evaluated, and routine telemetry information and noise is eliminated from the processing and analysis. As such, the processing and analysis of time stamp window based RTRs results in greater processing efficiency, and provides a first degree of scalability to an enterprise's DDoS protection efforts.

Further note that, because the time stamp window based RTRs aggregate the telemetry information from all of the elements of a cloud network into a single article for processing and analyzing, the time stamp window based RTR provides a second degree of scalability to the enterprise's DDoS protection efforts. More particularly, as a client's presence on the cloud network grows, and more resources are added to the cloud network, the volume of raw telemetry information increases linearly. However, by focusing the processing and analysis on the time stamp window based RTR, no matter how much the cloud network scales, the size and complexity of the RTR, and thus the processing and analysis thereof remains relatively constant. Note that, in a particular embodiment, as the client's presence on the cloud network scales, the client may opt to store additional critical telemetry parameters in the RTR, but such an increase in the scope of the critical telemetry parameters in the RTR does not necessarily cause the growth in RTR information increase as much as the growth in the cloud network.

Moreover, where client 320 receives the services from cloud computing system 310 according to an PaaS model or a SaaS model, with limited insight into the operation of the cloud computing system, the implementation of a DPS similar to DPS 330 provides the client with an improved ability to implement, monitor, and control the protection of DDoS attacks that are narrowly targeted to the client's services, above and beyond the efforts of the cloud service provider to provide more generally focused DDoS attack protection. Thus the use of a DPS to provide time stamp window based RTRs improves the associated cloud network's ability to receive, monitor, and process log information from the cloud network, and to effectively provide DDoS protection that is targeted to the client's needs.

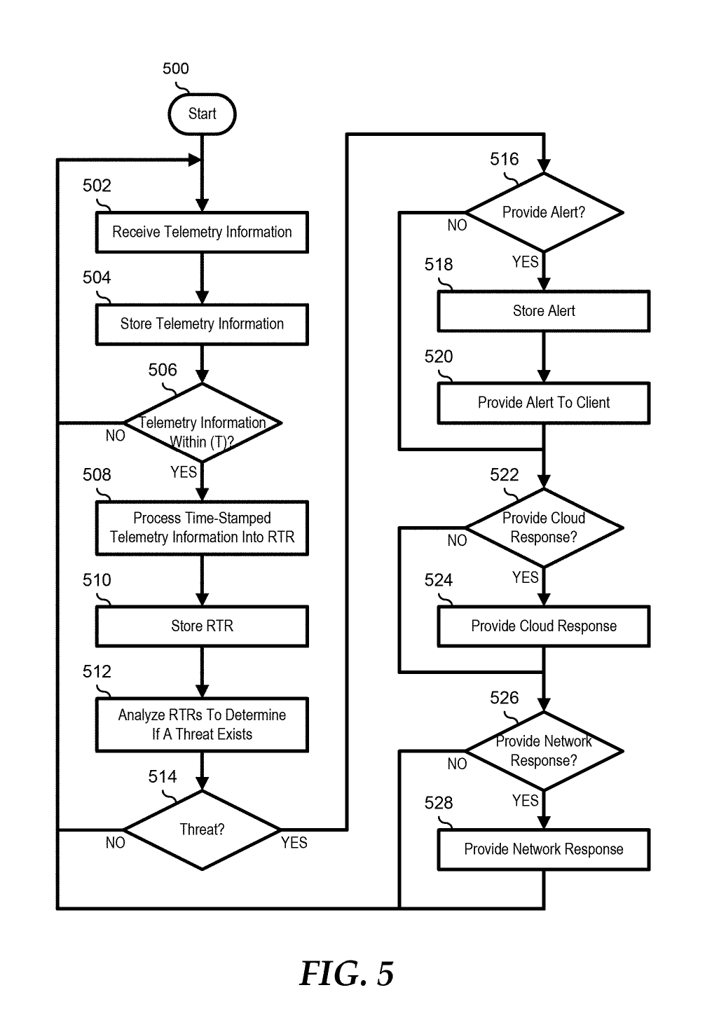

FIG. 5 illustrates a method of providing DDoS attack protection in a cloud network similar to cloud network 300, starting at block 500. Telemetry information from a cloud network is received by a DPS in block 502, and the telemetry information is stored to a telemetry archive in block 504. For example, a DDoS protection system can receive telemetry information from a routing network of a cloud network and from elements of a cloud processing system and can store the telemetry information to a telemetry archive. A decision is made as to whether the telemetry information that is provided was generated within a time stamp window (T) in decision block 506. For example, a time stamp window can be set to record critical telemetry parameters that are received within a time stamp window with a duration of 1 (one) second. If the telemetry information was not generated within a time stamp window (T), the “NO” branch of decision block 506 is taken and the method returns to block 502, where the telemetry information from the cloud network is received by the DPS.

If the telemetry information was generated within the time stamp window (T), the “YES” branch of decision block 506 is taken and a telemetry processor of the DPS processes the time stamped telemetry information to determine the critical telemetry parameters and create a Reaction Telemetry Record (RTR) in block 508, and the telemetry processor stores the RTR in an RTR database in block 510. The telemetry processor provides the RTR to a threat analyzer of the DPS, and the threat analyzer analyzes the RTR to determine if a threat exists on the cloud network in block 512. For example, the threat analyzer can compare the RTR with the signatures of known threats from a threat database to determine if the RTR matches the known threats. A decision is made as to whether or not the RTR identifies a threat in decision block 514. If not, the “NO” branch of decision block 514 is taken and the method returns to block 502, where the telemetry information from the cloud network is received by the DPS.

If the RTR identifies a threat, the “YES” branch of decision block 514 is taken and the threat analyzer provides a threat indication to an event reactor of the DPS, and a decision is made as to whether or not an alert should be provided in response to the threat indication in decision block 516. If not, the “NO” branch of decision block 516 is taken and the method proceeds to decision block 522 as described below. For example, the event reactor may determine that a particular threat indication is not to generate an alert, but is to be handled without providing an alert to the client. If an alert is to be provided, the “YES” branch of decision block 516 is taken, the alert is stored by the event reactor in an event log in block 518, the alert is provided to an alert generator of the DPS to provide the alert to the client in block 520, and the method proceeds to decision block 522 as described below.

If the “NO” branch of decision block 516 is taken, or if the alert is provided by the alert generator to the client in block 520, then a decision is made as to whether or not the event reactor should provide a cloud-based response to the event in decision block 522. If not, the “NO” branch of decision block 522 is taken and the method proceeds to decision block 526 as described below. For example, the event reactor may determine that a particular threat indication is not to generate a cloud-based response. If a cloud-based response is to be provided, the “YES” branch of decision block 522 is taken, a response is provided to a cloud response speaker of the DPS and the cloud response speaker provides the response to the cloud processing system to protect the cloud processing system from the DDoS attack in block 524, and the method proceeds to decision block 526 as described below.

If the “NO” branch of decision block 522 is taken, or if the response is provided by the cloud response speaker to the cloud processing system in block 524, then a decision is made as to whether or not the event reactor should provide a network-based response to the event in decision block 526. If not, the “NO” branch of decision block 526 is taken and the method returns to block 502, where the telemetry information from the cloud network is received by the DPS. For example, the event reactor may determine that a particular threat indication is not to generate a network-based response. If a network-based response is to be provided, the “YES” branch of decision block 526 is taken, a response is provided to a BGP speaker of the DPS and the BGP speaker provides the response to a routing network of the cloud network to protect the cloud network from the DDoS attack in block 528, and the method returns to block 502, where the telemetry information from the cloud network is received by the DPS.

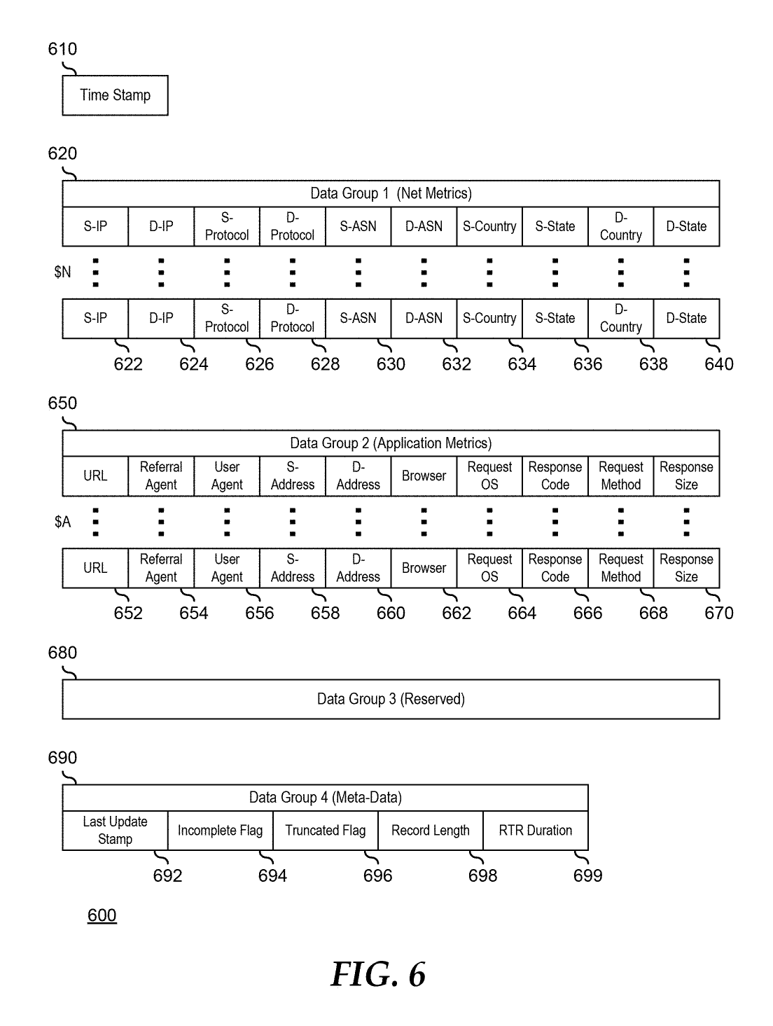

FIG. 6 illustrates an embodiment of an RTR 600, including a time stamp field 610 and four data groups 620, 650, 680, and 690. Time stamp field 610 provides a record of the time stamp window for RTR 600. In a particular embodiment, time stamp field 610 provides a time stamp window of 1 (one) second. An example of a time stamp included in time stamp field 610 includes a time stamp that is formatted in and extended DATE+TIME format per the ISO 8601 standard. For example, where time stamp field 610 includes a time stamp of “2016-04-13T23:09:56,” RTR 600 will include telemetry information that is received between 23:09:56:000 and 23:09:56:999. Data group 620 includes network based telemetry information that is selected as the top $N network metrics, where $N is configurable and represents a fidelity for the network metrics in the database of RTRs. For example, $N can equal 5 entries for each network metric, 10 entries for each network metric, or another number of entries for each network metric. The network metrics stored in data group 620 includes the $N top source IP addresses 622, the $N top destination IP addresses 624, the $N top source protocols 626, the $N top destination protocols 628, the $N top source Autonomous System Numbers (ASNs) 630, the $N top destination ASNs 632, the $N top source location country 634, the $N top source location state/province 636, the $N top destination location country 638, and the $N top destination location state/province 640. The top $N network metrics can be determined by traffic flow in bits per second (bps) or in packets per second (pps), as needed or desired.

Data group 650 includes application based telemetry information that is selected as the top $A application metrics, where $A is configurable and represents a fidelity of the application metrics in the database of RTRs. For example, $A can equal 5 entries for each application metric, 10 entries for each application metric, or another number of entries for each application metric. The application metrics stored in data group 650 includes the $A top requested Uniform Resource Locators (URLs) 652, the $A top destination IP referral agents 654, the $A top user agents 656, the $A top source addresses 658, the $A top destination addresses 660, the $A top referring browsers 662, the $A top requesting Operating Systems (OS) 664, the $A top response codes 666, the $A top request methods 668, and the $A top response sizes 670. In a particular embodiment, data group 650 may not include the referring browser 662 or the OS 664 fields, and the referring browser and OS information is derived from the user agent 656 field.

Data group 680 is a reserved data group for future expansion, as needed or desired. Data group 690 includes meta-data associated with RTR 600, and includes a last update time stamp field 692, an incomplete flag 694, a truncated flag 696, a record length field 698, and an RTR duration field 699. Last update time stamp field 692 contains a time stamp associated with a most recent update of RTR 600. In a particular embodiment, when RTR 600 is created, last update time stamp field 692 includes the same information as time stamp field 610, thereby indicating that the RTR is unmodified. In another embodiment, when RTR 600 is created, last update time stamp field 692 is empty, thereby indicating that the RTR is unmodified. Incomplete flag 694 provides an indication that one or more of the fields of RTR 600 has not been filled, but that additional telemetry information is expected in order to complete the RTR. For example, at the time that RTR 600 was created, all of the contributing network telemetry information may not have been received, such as where $N is equal to 10 (ten), and only 5 (five) network elements may have provided telemetry information. Truncated flag 696 provides an indication that one or more of the fields of RTR 600 have not been filled, but that no additional telemetry information is expected and the RTR generation is complete. For example, at the time that RTR 600 was created, all of the contributing application telemetry information may have been received, but there were not $A different values were received, such as were AN is equal to 10 (ten), but only 5 (five) different browsers were utilized in accessing the application elements. Record length field 698 includes a value for the length of RTR 600. In a particular embodiment, record length field 698 represents a number of bytes of information in RTR 600, or another measure of the length of the RTR, as needed or desired. RTR duration field 699 provides an indication as to the duration of the time stamp window associated with RTR 600. For example, where a time stamp window associated with RTR 600 is one (1) second, then RTR duration field 699 will indicate that the RTR is associated with a one (1) second time stamp window. In a particular embodiment, RTR duration field 699 includes a number of seconds. For example, where a time stamp window associated with RTR 600 is two (2) minutes, then RTR duration field 699 will indicate that the time stamp window associated with RTR 600 is 120 seconds.

RTR 600 is generated by a telemetry processor, such as telemetry processor 410 in FIG. 4, described above. In particular, a client can configure the telemetry processor to generate RTR 600, or to change the configuration process whereby the telemetry processor generates RTRs. In a particular embodiment, a client can configure RTR 600 such that $N and $A are the same number, or such that $N is different from $A. For example, where a particular client manages their own edge routing, that client might want to store a deeper set of network metrics, while another client that provides more extensive application services might want to store a deeper set of application metrics. In another embodiment, a client can configure the telemetry processor to add or remove fields from one or more of data groups 620 and 650. For example, where new DDoS attacks are determined to be directed to a particular service that is provided on a particular socket port, the client may wish to add a field to data group 650 that identifies the top $A accessed socket ports. In yet another embodiment, a client can configure the telemetry processor to filter the incoming telemetry information, so as to limit or focus the resulting RTRs. In particular, the telemetry processor can filter the telemetry information based upon the element of the cloud network that generated the telemetry information. For example, the telemetry processor may be configured to only generate RTR 600 based upon telemetry information received from the edge routers of the cloud network. Here, a customized RTR can be generated along with an associated RTR database that is focused to detect volume DDoS attacks. In another example, a telemetry processor may be configured to generate RTR 600 based upon only application telemetry information from a particular component of a cloud network, but not upon network telemetry information from the same component. For example, where an application focused RTR is desired, the telemetry processor may be configured to generate RTR 600 based upon application telemetry information from a cloud management system, but not based upon network telemetry information from the cloud management system. In yet another example, RTR 600 can be focused upon a particular application, and the telemetry processor can generate the RTR by filtering the application telemetry information based upon the source application. For example, where an application server provides both web-based services and an e-mail client, the telemetry processor can filter out the web service telemetry information to generate an RTR and an associated RTR database that is focused on the e-mail application.

In a particular embodiment, a telemetry processor can dynamically determine the fields that are included in RTR 600. Here, the telemetry processor may retain one or more previously generated RTRs, or the raw telemetry information that was used to generate the RTRs. Here further, the telemetry processor may be configured to detect when the telemetry information for a field that is not captured in RTR 600 is experiencing an unusual rise in activity, based upon the raw telemetry information. For example, where RTR 600 does not include a particular socket port as a captured field, but where the telemetry processor detects that, over time, the traffic to a particular socket port is experiencing an increased level of activity, the telemetry processor can be configured to add the socket port field in generating future RTRs. Here, the telemetry processor can include various trending analysis tools as are known in the art in determining whether or not to add a particular field to RTR 600. Note that based upon the configurability of RTRs by a telemetry processor, one or more RTR databases can be maintained that are each highly focused on different types of threats, and the RTRs provide flexibility to respond to the evolving threat environment.

The following tables provide an example of the generation of an RTR in accordance with the present disclosure. Table 1 illustrates raw telemetry information from a first source device, Source A, and a second source device, Source B. The telemetry information includes source and destination IP addresses for transactions handled by the first and second source devices. Table 2 illustrates the resulting RTR. Note that the third entry in the RTR is not derived directly from either Source A or Source B, but is an entry based upon an aggregate of the information from Source A and Source B.

TABLE 1
Raw Telemetry Information

| Source A | | Source B | |
|---|---|---|---|
| Source IP | Destination IP | Source IP | Destination IP |
| 192.168.100.96 | 10.10.220.1 | 192.168.100.47 | 10.0.1.5 |
| 192.168.100.179 | 10.10.2.11 | 192.168.100.47 | 10.0.1.5 |
| 192.168.100.96 | 10.10.220.1 | 192.168.100.213 | 10.0.1.10 |
| 192.168.100.96 | 10.10.220.1 | 192.168.100.45 | 10.45.3.5 |
| 192.168.100.175 | 10.10.2.12 | 192.168.100.22 | 10.0.1.2 |
| 192.168.100.45 | 10.45.3.5 | 192.168.100.47 | 10.0.1.5 |

TABLE 2
Reactor Telemetry Record

| Top Source IP | Count | Top Destination IP | Count |
|---|---|---|---|
| 192.168.100.96 | 3 | 10.10.220.1 | 3 |
| 192.168.100.47 | 3 | 10.0.1.5 | 3 |
| 192.168.100.45 | 2 | 10.45.3.5 | 2 |

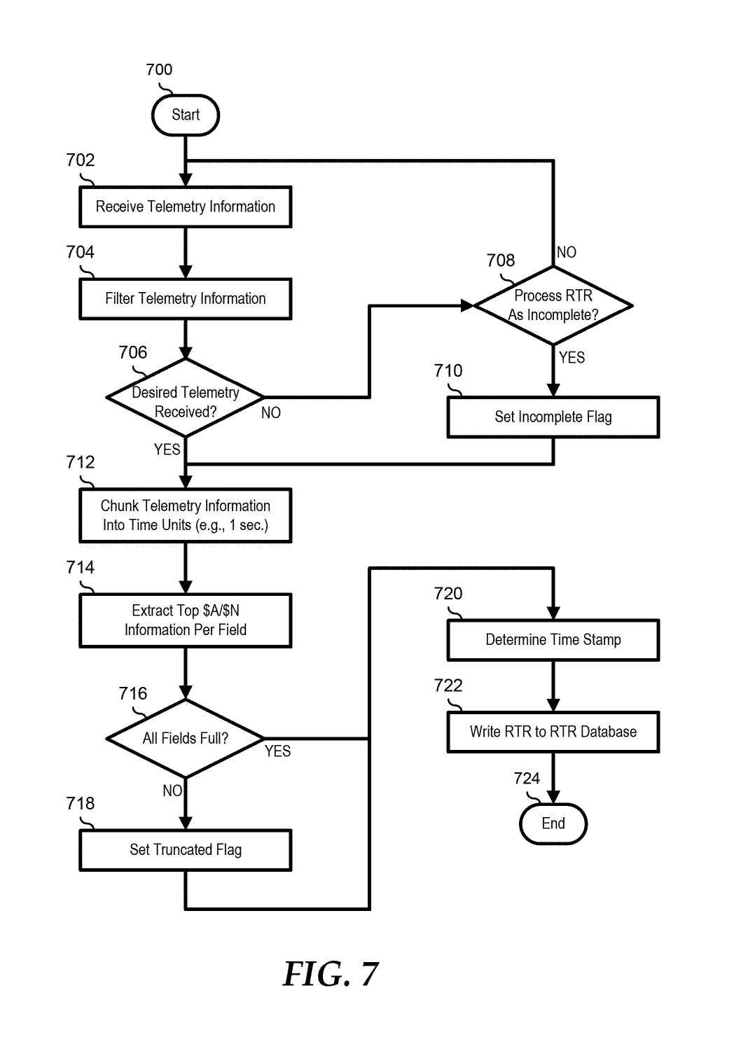

FIG. 7 illustrates a method of generating an RTR, starting at block 700. Telemetry information from a cloud network is received by a telemetry processor in block 702, and the telemetry processor filters the received telemetry information in accordance with the configuration of one or more desired RTRs in block 704. A decision is made as to whether or not the desired telemetry information has been received in decision block 706. For example, a predetermined amount of time since a previous RTR was generated may have elapsed, after which a new RTR is to be generated. If the desired telemetry information has been received, the “YES” branch of decision block 706 is taken and the method proceeds to block 712. If the desired telemetry information has not been received, the “NO” branch of decision block 706 is taken and a decision is made as to whether or not to process the RTR as an incomplete RTR in decision block 708. If not, the “NO” branch of decision block 708 is taken and the method returns to block 702 where the telemetry information is received. If the RTR is to be processed as an incomplete RTR, the “YES” branch of decision block 708 is taken, the incomplete flag of the RTR is set in block 710, and the method proceeds to block 712.

When the desired telemetry information has been received and the “YES” branch of decision block 706 is taken, or when the incomplete flag of the RTR is set in block 710, the telemetry information is chunked into time units in block 712. For example, where the RTRs are configured to capture 1 second of telemetry information, the telemetry information is chunked into 1 second blocks. The top $A application telemetry information per field of the application data group and the top $N network telemetry information is extracted per field of the network data group in block 714. A decision is made as to whether or not all of the data fields of the RTR are full in decision block 716. If not, the “NO” branch of decision block 716 is taken, the truncated flag of the RTR is set in block 718, and the method proceeds to block 720. If all of the data fields of the RTR are full, the “YES” branch of decision block 716, and the method proceeds to block 720 where the time stamp for the RTR is determined. The RTR is written to the RTR database in block 722, and the method ends in block 724.

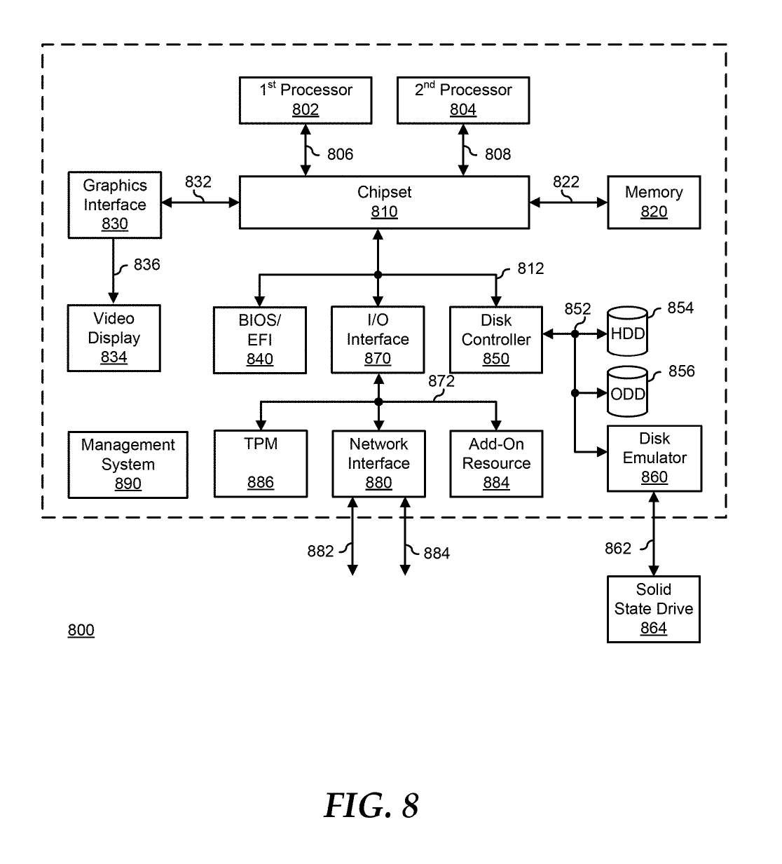

FIG. 8 illustrates a generalized embodiment of information handling system 800. For purpose of this disclosure information handling system 800 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described above, and operates to perform one or more of the methods described above. Information handling system 800 includes a processors 802 and 804, a chipset 810, a memory 820, a graphics interface 830, include a basic input and output system/extensible firmware interface (BIOS/EFI) module 840, a disk controller 850, a disk emulator 860, an input/output (I/O) interface 870, a network interface 880, and a management system 890. Processor 802 is connected to chipset 810 via processor interface 806, and processor 804 is connected to the chipset via processor interface 808. Memory 820 is connected to chipset 810 via a memory bus 822. Graphics interface 830 is connected to chipset 810 via a graphics interface 832, and provides a video display output 836 to a video display 834. In a particular embodiment, information handling system 800 includes separate memories that are dedicated to each of processors 802 and 804 via separate memory interfaces. An example of memory 820 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 840, disk controller 850, and I/O interface 870 are connected to chipset 810 via an I/O channel 812. An example of I/O channel 812 includes a Peripheral Component Interconnect (PCI) interface, a PCI-Extended (PCI-X) interface, a high speed PCI-Express (PCIe) interface, another industry standard or proprietary communication interface, or a combination thereof. Chipset 810 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 840 includes BIOS/EFI code operable to detect resources within information handling system 800, to provide drivers for the resources, initialize the resources, and access the resources. BIOS/EFI module 840 includes code that operates to detect resources within information handling system 800, to provide drivers for the resources, to initialize the resources, and to access the resources.

Disk controller 850 includes a disk interface 852 that connects the disc controller to a hard disk drive (HDD) 854, to an optical disk drive (ODD) 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits a solid-state drive 864 to be connected to information handling system 800 via an external interface 862. An example of external interface 862 includes a USB interface, an IEEE 1394 (Firewire) interface, a proprietary interface, or a combination thereof. Alternatively, solid-state drive 864 can be disposed within information handling system 800.

I/O interface 870 includes a peripheral interface 872 that connects the I/O interface to an add-on resource 874, to a TPM 876, and to network interface 880. Peripheral interface 872 can be the same type of interface as I/O channel 812, or can be a different type of interface. As such, I/O interface 870 extends the capacity of I/O channel 812 when peripheral interface 872 and the I/O channel are of the same type, and the I/O interface translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as chipset 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Management system 890 provides for out-of-band monitoring, management, and control of the respective elements of information handling system 800, such as cooling fan speed control, power supply management, hot-swap and hot-plug management, firmware management and update management for system BIOS or UEFI, Option ROM, device firmware, and the like, or other system management and control operations as needed or desired. As such, management system 890 provides some or all of the operations and features of the management systems, management controllers, embedded controllers, or other embedded devices or systems, as described herein.

The preceding description in combination with the Figures is provided to assist in understanding the teachings disclosed herein. The preceding discussion focused on specific implementations and embodiments of the teachings. This focus has been provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data network for providing protection against directed denial of service (DDoS) attacks, the data network comprising:
a data processor to provide an application to a user system, the data processor configured to provide first time-stamped telemetry information related to the application;
a network device coupled to route application data traffic between the data processor and the user system, the network device configured to provide second time-stamped telemetry information related to the data traffic; and
a DDoS Protection System (DPS) configured to receive the first time stamped telemetry information and the second time-stamped telemetry information, to delimit the first and second time-stamped telemetry information into telemetry information chunks, each telemetry information chunk comprising that portion of the first and second time-stamped telemetry information having a time-stamp that is within a corresponding time-stamp window, each particular time stamp window being contiguous with and exclusive of a next time stamp window, to process each telemetry information chunk in to a Reactor Telemetry Record (RTR), the RTR comprising a selected portion of the corresponding telemetry information chunk, to analyze the RTRs to determine if the data network is experiencing a DDoS attack, and to initiate a response when the data network is experiencing a DDoS attack.

2. The data network of claim 1, wherein each telemetry information chunk comprises that portion of the first and second time-stamped telemetry information that is time-stamped with time stamp information that is within a time stamp window of less than 10 (ten) seconds.

3. The data network of claim 1, wherein each telemetry information chunk comprises that portion of the first and second time-stamped telemetry information that is time-stamped with time stamp information that is within a time stamp window of 1 (one) second.

4. The data network of claim 1, wherein the selected portion of the telemetry information chunk comprises a top A most common entries for each of a plurality of application metrics from the associated application telemetry information, where A is an integer.

5. The data network of claim 4, wherein the plurality of application metrics comprises at least one of a requested Uniform Resource Locator (URL), a destination IP referral agent, a user agent, a source address, a destination address, a referring browser, a requesting Operating Systems (OS), a response code, a request method 668, and a response size.

6. The data network of claim 1, wherein the selected portion of the telemetry information chunk comprises a top N most common network metrics from the associated network telemetry information, where N is an integer.

7. The data network of claim 6, wherein the plurality of network metrics comprises at least one of a source IP address, a destination IP address, a source protocol, a destination protocol, a source Autonomous System Number (ASN), a destination ASN, a source location country, a source location state/province, a destination location country, and a destination location state/province.

8. The data network of claim 7, wherein the top N network metrics is determined based upon a traffic flow as measured in one of bits per second (bps) or packets per second (pps).

9. The data network of claim 1, wherein the response comprises data processor response information directed to the data processor to modify a processing function of the data processor.

10. The data network of claim 9, wherein the data processor response information includes one of a flow restriction and a route restriction.

11. The data network of claim 1, wherein the response comprises network response information directed to the network device to modify a routing behavior of the network device.

12. The data network of claim 11, wherein the network response information includes one of an address restriction, a flow restriction, an Access Control List (ACL) entry, an IP black list entry, and a MAC address black list entry.

13. A method for protecting against directed denial of service protection (DDoS) attacks on a data network, the method comprising:
receiving, at a DDoS protection system (DPS), first time-stamped telemetry information from a data processor configured to provide an application to a user system;
receiving, at the DPS, second time-stamped telemetry information from a network device coupled to route application traffic between the data processor and the user system;
delimiting, by the DPS, the first and second time-stamped telemetry information into telemetry information chunks, each telemetry information chunk comprising that portion of the first and second time-stamped telemetry information that is time-stamped with time stamp information that is within a particular time stamp window, each particular time stamp window being contiguous with and exclusive of a next time stamp window,
processing, by the DPS, each telemetry information chunk in to a Reactor Telemetry Record (RTR), the RTR comprising a selected portion of the corresponding telemetry information chunk,
analyzing, by the DPS, the RTRs to determine if the data network is experiencing a DDoS attack, and
initiating, by the DPS, a response when the data network is experiencing a DDoS attack.

14. The method of claim 13, wherein the selected portion of the telemetry information chunk comprises a top A most common entries for each of a plurality of application metrics from the associated application telemetry information, where A is an integer.

15. The method of claim 13, wherein the selected portion of the telemetry information chunk comprises a top N most common network metrics from the associated network telemetry information, where N is an integer.

16. The method of claim 13, wherein the response comprises one of data processor response information directed to the data processor to modify a processing function of the data processor and network response information directed to the network device to modify a routing behavior of the network device.

17. A non-transitory computer-readable medium including code for performing a method for implementing a directed denial of service protection system, the method comprising:
receiving, at a DDoS protection system (DPS), first time-stamped telemetry information from a data processor configured to provide an application to a user system;
receiving, at the DPS, second time-stamped telemetry information from a network device coupled to route application traffic between the data processor and the user system;
delimiting, by the DPS, the first and second time-stamped telemetry information into telemetry information chunks, each telemetry information chunk comprising that portion of the first and second time-stamped telemetry information that is time-stamped with time stamp information that is within a particular time stamp window, each particular time stamp window being contiguous with and exclusive of a next time stamp window,
processing, by the DPS, each telemetry information chunk in to a Reactor Telemetry Record (RTR), the RTR comprising a selected portion of the corresponding telemetry information chunk,
analyzing, by the DPS, the RTRs to determine if the data network is experiencing a DDoS attack, and
initiating, by the DPS, a response when the data network is experiencing a DDoS attack.

18. The computer-readable medium of claim 17, wherein the selected portion of the telemetry information chunk comprises a top A most common entries for each of a plurality of application metrics from the associated application telemetry information, where A is an integer.

19. The computer-readable medium of claim 17, wherein the selected portion of the telemetry information chunk comprises a top N most common network metrics from the associated network telemetry information, where N is an integer.

20. The computer-readable medium of claim 17, wherein the response comprises one of data processor response information directed to the data processor to modify a processing function of the data processor and network response information directed to the network device to modify a routing behavior of the network device.
